(19) United States
(12) Patent Application Publication
(10) Pub. No.: US 2026/0134528 A1
(43) Pub. Date: May 14, 2026

(54) NON-TRANSITORY COMPUTER-READABLE RECORDING MEDIUM, ESTIMATION METHOD, AND INFORMATION PROCESSING APPARATUS

(71) Applicants: Fujitsu Limited, Kawasaki-shi (JP); RIKEN, Wako-shi (JP)

(72) Inventors: Mutsuyo WADA, Funabashi (JP); Atsushi TOKUHISA, Wako (JP); Yuichiro WADA, Kawasaki (JP); Kimihiro YAMAZAKI, Ohta (JP); Mitsunori TOMA, Suginami (JP); Hiyori YOSHIKAWA, Kawasaki (JP); Yoshiyuki ISHII, Kawasaki (JP); TAKASHI KATOH, Kawasaki (JP); Akira NAKAGAWA, Sagamihara (JP)

(73) Assignees: Fujitsu Limited, Kawasaki-shi (JP); RIKEN, Wako-shi (JP)

(21) Appl. No.: 19/380,998

(22) Filed: Nov. 6, 2025

(30) Foreign Application Priority Data
Nov. 8, 2024 (JP) 2024-196330

(51) Int. Cl. G06T 7/00

(52) U.S. Cl. CPC G06T 7/00; G06T 2207/10056; G06T 2207/20081; G06T 2207/20084

(57) ABSTRACT

A non-transitory computer-readable recording medium has stored therein a program that causes a computer to execute a process including acquiring a distribution of latent variables output from an encoder in a process of training an autoencoder, generating a path related to deformation based on the distribution of the latent variables, selecting, from a plurality of latent variables generated by inputting a plurality of particle images to the trained encoder, a plurality of neighboring latent variables of which a distance to the path is less than a threshold, selecting a plurality of neighboring particle images corresponding to the plurality of neighboring latent variables among the plurality of particle images, and estimating a plurality of three-dimensional atom models based on the plurality of neighboring particle images.

### CROSS-REFERENCE TO RELATED APPLICATION

This application is based upon and claims the benefit of priority of the prior Japanese Patent Application No. 2024-196330, filed on Nov. 8, 2024, the entire contents of which are incorporated herein by reference.

### FIELD

The embodiment discussed herein is related to a computer-readable recording medium and the like.

### BACKGROUND

A cryogenic electron microscopy (cryoEM) is used in order to improve efficiency of drug discovery or the like. A cryoEM is an apparatus (scheme) irradiating biomolecules such as proteins with an electron beam under liquid nitrogen cooling to observe a sample. For example, techniques of the related art related to cryoEM include techniques 1 and 2 of the related art.

The technique 1 of the related art is a technique for estimating continuous deformation of a three-dimensional density map from a two-dimensional cryoEM particle image group obtained by cryoEM using an autoencoder. The technique 2 of the related art is a technique for estimating a likelihood three-dimensional atom model from each two-dimensional cryoEM particle image while maintaining protein likeness using a molecular dynamics (MD) simulation.

FIG. 15 is a diagram illustrating an example of a three-dimensional atom model and a three-dimensional density map. For example, a three-dimensional atom model 5A is a model that expresses a three-dimensional structure of the entire protein by expressing a bond between atoms of each amino acid residue contained in the protein with a line segment. On the other hand, a three-dimensional density map 5B is data that represents a distribution of electron density of a protein and is used to visualize a shape and a structure of the protein.

There is also a technique 3 of the related art in which a three-dimensional density map and a three-dimensional atom model of a typical structure are acquired in pairs, and the typical structure is moved and fitted to the three-dimensional density map.

Here, at the present time, there is no technique for estimating likelihood continuous deformation of a three-dimensional atom model of a protein from a two-dimensional cryoEM particle image group. However, it is considered that it is potentially possible to estimate the likelihood continuous deformation of the three-dimensional atom model of the protein by combining the above-described techniques 1 and 2 (or 3) of the related art.
Non Patent Literature 1: Trabuco, Leonardo G., et al. “Molecular dynamics flexible fitting: a practical guide to combine cryo-electron microscopy and X-ray crystallography.” Methods 49.2, 174-180 (2009)

### SUMMARY

According to an aspect of an embodiment, a non-transitory computer-readable recording medium has stored therein a program that causes a computer to execute a process including acquiring a distribution of latent variables output from an encoder in a process of training an autoencoder having the encoder and a decoder using a plurality of pieces of training data having a particle image of a polymer as an explanatory variable and having a three-dimensional density map of the polymer as an objective variable generating a path related to deformation based on the distribution of the latent variables selecting, from a plurality of latent variables generated by inputting a plurality of particle images to the trained encoder, a plurality of neighboring latent variables of which a distance to the path is less than a threshold selecting a plurality of neighboring particle images corresponding to the plurality of neighboring latent variables among the plurality of particle images and estimating a plurality of three-dimensional atom models based on the plurality of neighboring particle images.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating CryoTWIN (PaStEL);

FIG. 2 is a diagram illustrating isometry;

FIG. 3 is a diagram illustrating processing for calculating continuous deformation of a likelihood path of a latent variable z;

FIG. 4 is a diagram illustrating a CryoTM method;

FIG. 5 is a diagram illustrating an MDFF;

FIG. 6 is a diagram (1) illustrating processing of the information processing apparatus according to the present embodiment;

FIG. 7 is a diagram illustrating a geodesic distance;

FIG. 8 is a diagram (2) illustrating processing of the information processing apparatus according to the present embodiment;

FIG. 9 is a functional block diagram illustrating a configuration of an information processing apparatus according to the present embodiment;

FIG. 10 is a diagram illustrating an example of a two-dimensional cryoEM particle image obtained in an experiment;

FIG. 11 is a diagram supplementarily illustrating processing of an estimation unit;

FIG. 12 is a flowchart illustrating a processing procedure of the information processing apparatus according to the present embodiment;

FIG. 13 is a diagram illustrating another processing (2) executed by the information processing apparatus;

FIG. 14 is a diagram illustrating an example of a hardware configuration of a computer that implements functions similar to those of the information processing apparatus according to the embodiment; and

FIG. 15 is a diagram illustrating an example of a three-dimensional atom model and a three-dimensional density map.

### DESCRIPTION OF EMBODIMENTS

However, there is a problem that it is not possible to accurately estimate the likelihood continuous deformation of the three-dimensional atom model of the protein only by simply combining the above-described techniques 1 and 2 (or 3) of the related art.

For example, in the three-dimensional density map estimated by the technique 1 of the related art, there is often an indefinite region with insufficient accuracy. When there is such an indefinite region, it is difficult to accurately fit a three-dimensional atom model (typical structure) to a three-dimensional density map.

Preferred embodiments of the present invention will be explained with reference to accompanying drawings. Note that the present invention is not limited by the examples.

Before the present embodiment is described, CryoTWIN (PaStEL) corresponding to the above-described technique 1 of the related art will be described more specifically. The CryoTWIN is, for example, spatial-RaDOGAGA (DeepTWIN). PaStEL is an abbreviation for generator of pathways with structural change on pseudo free-energy landscape from Cryo-EM Images.

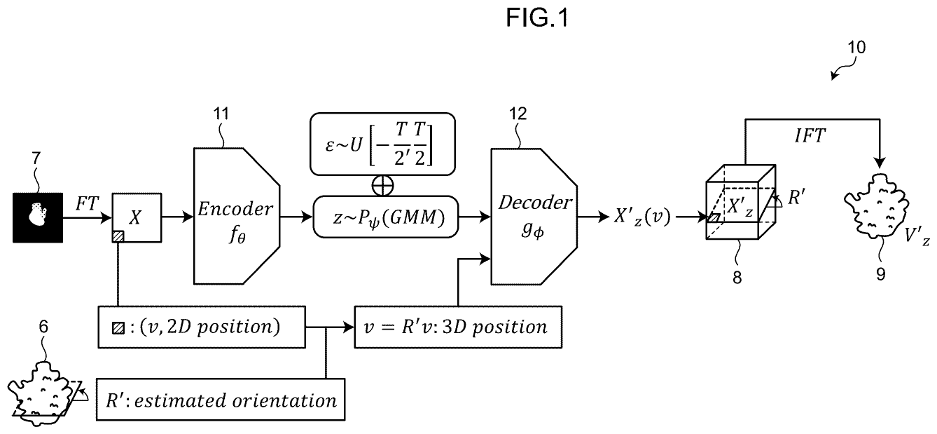

FIG. 1 is a diagram illustrating a CryoTWIN (PaStEL). As illustrated in FIG. 1, a CryoTWIN 10 includes an encoder 11 and a decoder 12. The CryoTWIN 10 applies a cryoEM to a DeepTWIN. Here, to facilitate description, an apparatus that executes processing related to the CryoTWIN 10 is referred to as an “apparatus”.

First, a flow of a series of processing in which an apparatus predicts a three-dimensional density map based on a plurality of particle images will be described.

For example, a plurality of particle images are generated by photographing a protein 6 from various orientations using the cryoEM. The apparatus generates a Fourier image X by executing Fourier transform (FT) on a particle image 7 obtained from the cryoEM. The apparatus calculates a latent variable z by inputting the Fourier image X to the encoder 11. The latent variable z follows P_{y} (GMM). The GMM is an abbreviation for a Gaussian mixture model. In the present embodiment, the protein will be described as an example, but the example of the protein may be a polymer, for example, a nucleic acid, a sugar chain, a lipid, or the like.

Subsequently, the apparatus calculates X′_{z}(v) by inputting latent variables z and v to the decoder 12. v represents a three-dimensional position and is defined by Formula (1). R′ in Formula (1) represents an orientation for the protein 6 when the particle image 7 is captured. v on the right side of Formula (1) represents a position (two-dimensional position) of the Fourier image X.

$$v = {R}^{′} v \qquad ( 1 )$$

X′_{z}(v) represents a value of the three-dimensional position v in a three-dimensional Fourier volume. The apparatus generates a three-dimensional Fourier volume 8 by repeatedly executing the above processing on a plurality of particle images obtained from the same protein 6. An apparatus predicts the three-dimensional density map 9 by executing inverse fast Fourier transform (IFT) on the three-dimensional Fourier volume.

Here, in the CryoTWIN, the encoder 11 and the decoder 12 are trained using a training data set. The training data set includes a plurality of pieces of training data. For example, an explanatory variable (input data) of the training data is a particle image of a protein. An objective variable (correct data) of the training data is a three-dimensional density map of a protein (three-dimensional Fourier volume corresponding to the three-dimensional density map, or the like).

The apparatus inputs the Fourier image obtained from the particle image of the training data to the encoder 11, and updates parameters of the encoder 11 and the decoder 12 so that a value output from the decoder 12 approaches the correct data. For example, the apparatus uses backpropagation. As described above, the apparatus inputs the Fourier image obtained by executing FT on the particle image to the encoder 11, and inputs the latent variables z and the value of the three-dimensional position v to the decoder 12.

The apparatus acquires the distribution of the latent variables z output from the encoder 11 in the processing for repeatedly executing the above processing using the plurality of pieces of training data included in the training data set. In the following description, the distribution of the latent variables z is referred to as a “latent distribution”.

The latent distribution obtained in a process of causing the apparatus to train the encoder 11 and the decoder 12 using the training data set has “isometry”.

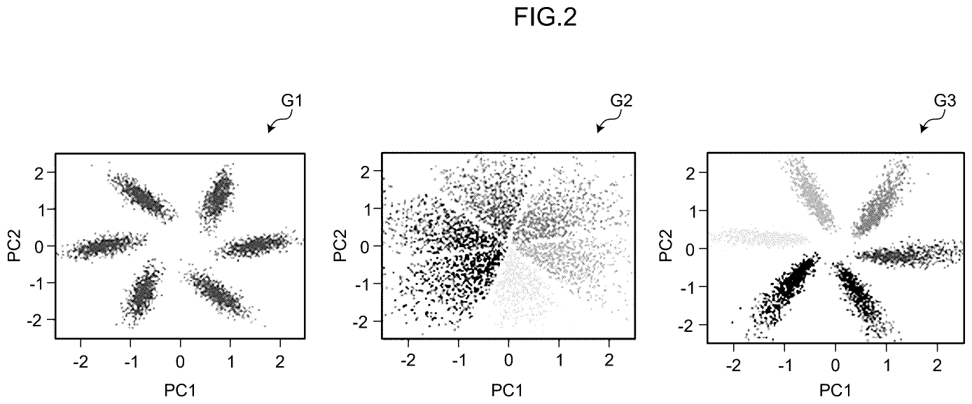

FIG. 2 is a diagram illustrating isometry. FIG. 2 illustrates graphs G1, G2, and G3. A graph G1 is a graph of a latent distribution obtained from a structure of an original protein (a plurality of proteins corresponding to the correct data). A graph G2 is a graph of a latent distribution obtained as a result of applying a variational autoencoder (spatial-VAE) to a plurality of proteins. A graph G3 is a graph of a latent distribution obtained from the encoder 11 described in FIG. 1 for a plurality of proteins.

The horizontal axis of each of the graphs G1, G2, and G3 is an axis corresponding to a first principal component (PC1) in principal component analysis. The vertical axis of each of the graphs G1, G2, and G3 is an axis corresponding to a second principal component (PC2) in the principal component analysis. One plot on the graphs G1, G2, and G3 corresponds to a structure of one protein.

In the graphs G1 and G3, plots of proteins having similar structures are densely packed, and there is isometry. Conversely, in the graph G2, plots of proteins having dissimilar structures are arranged close to each other, and there is no isometry. The reason for the lack of isometry is that the structure of the original protein is distorted by N(z;0, I_{d}).

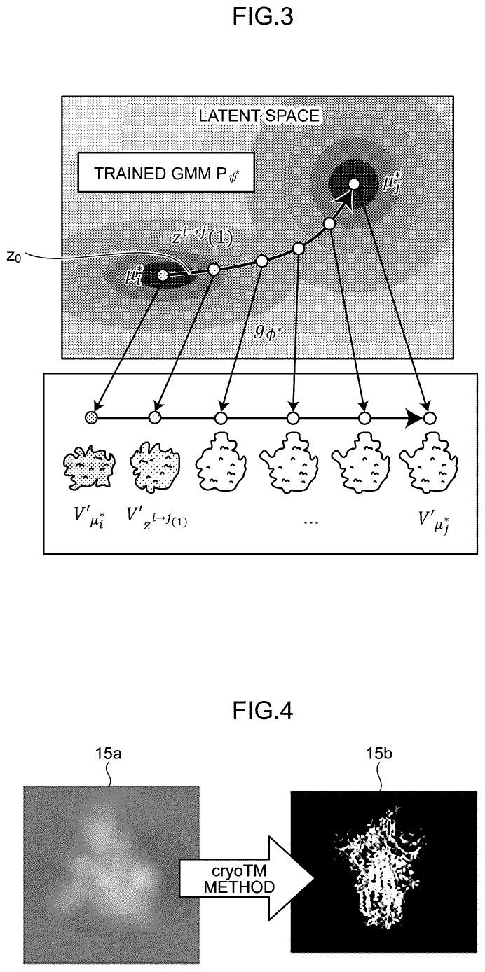

Here, in CryoTWIN (PaStEL), continuous deformation of a likelihood path of the latent variable z is calculated based on the latent distribution obtained using the training data set. FIG. 3 is a diagram illustrating processing for calculating a continuous deformation of a likelihood path of the latent variable z. In the latent space of FIG. 3, a latent distribution obtained during training is placed. A probability is set in each latent variable z included in the latent distribution. In the latent space, a dark color portion indicates that the probability of the latent variable z is higher.

The apparatus generates a likelihood path z₀ from μ*ᵢ to μ*ⱼ based on the following first and second standards. For example, the path z₀ is expressed in Formula (2).

$$Path {z}_{0} = {μ}_{i}^{⋆} \to {z}_{1} \to {z}_{2} … \to {z}_{K - 1} \to {z}_{K} = {μ}_{j}^{⋆} \qquad ( 2 )$$

The first standard is a standard for making a sum value of probabilities of the latent variables z on the path z₀ as large as possible. For example, the sum value of the probabilities on the path z₀ is expressed in Formula (3).

$${\sum }_{k = 0}^{K} {P}_{ψ ′} ( {z}_{k} ) \qquad ( 3 )$$

The second standard is a standard for making the path length as short as possible. For example, the path length is expressed in Formula (4).

$${\sum }_{k = 0}^{K} {‖ {z}_{k} - {z}_{k - 1} ‖}_{2} \qquad ( 4 )$$

The apparatus inputs the path z₀ to the trained decoder 12 to obtain continuous deformation of the three-dimensional density structure as indicated in Formula (5).

$${V}_{μ {′}_{i}}^{′} \to {V}_{{z}_{1}}^{′} \to … \to {V}_{{z}_{K - 1}}^{′} \to {V}_{μ {′}_{j}}^{′} \qquad ( 5 )$$

For example, by inputting the latent variable z obtained during training to the trained decoder 12, a three-dimensional density structure V′_{z} can be started. Therefore, the latent variable z and the three-dimensional density structure V′_{z} can be equated.

Further, the latent distribution is a Gaussian distribution P_{ψ}′(z) as indicated in Formula (6), and has isometry as described in FIG. 2. Therefore, the latent distribution can be interpreted as an existence distribution of the three-dimensional density structure V′_{z} and can be defined as in Formula (7).

$${P}_{ψ ′} ( z ) = {\sum }_{c = 1}^{C} {π}_{c}^{′} N ( z ; {μ}_{c}^{′} , {Σ}_{c}^{′} ) \qquad ( 6 )$$

$${‖ z - {z}^{′} ‖}_{2} ∝ {‖ {V}_{z}^{′} - {V}_{z ′}^{′} ‖}_{2} \qquad ( 7 )$$

Next, a CryoTM (template matching) method corresponding to the above-described technique 2 of the related art will be described more specifically. FIG. 4 is a diagram illustrating the CryoTM method. In the CryoTM method, a two-dimensional cryoEM particle image 15a and an initial three-dimensional atom model (not illustrated) are used as inputs, and a multistage structure search using MD is executed to estimate a three-dimensional atom model 15b.

For example, in the CryoTM method, image matching is executed on various candidate structures obtained by structure sampling for the initial three-dimensional atom model and the two-dimensional cryoEM particle image 15a in consideration of the degree of freedom of a molecular orientation, and a similarity value of each candidate structure is calculated. In the CryoTM method, for example, a candidate structure having a maximum similarity value is estimated as a likelihood three-dimensional atom model 15b for the two-dimensional cryoEM particle image 15a.

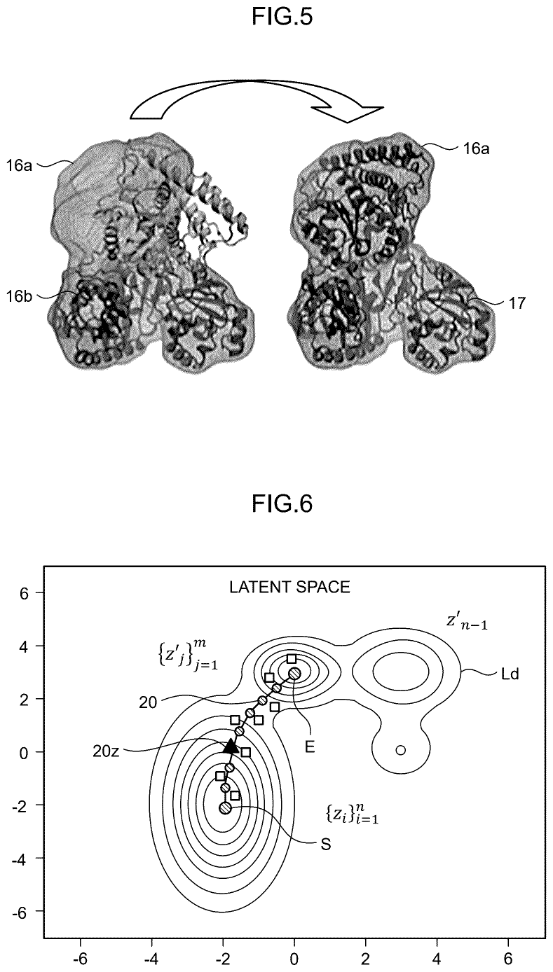

Next, molecular dynamics flexible fitting (MDFF) corresponding to the above-described technique 3 of the related art will be described in more detail. FIG. 5 is a diagram illustrating the MDFF. In the MDFF, a three-dimensional density map 16a and a three-dimensional atom model 16b of a typical structure are acquired in pairs, and a three-dimensional atom model 17 is estimated by changing the structure such that the three-dimensional atom model 16b is fitted to the three-dimensional density map 16a. In the MDFF, when the three-dimensional atom model 16b is moved, the MD to which an external force corresponding to a gradient of the three-dimensional density map 16a is applied is used.

The techniques 1, 2, and 3 of the related art have been more specifically described above.

Next, an information processing apparatus according to the present embodiment will be described. FIG. 6 is a diagram (1) illustrating processing of the information processing apparatus according to the present embodiment. In the following description, the information processing apparatus according to the present embodiment will be referred to as an “information processing apparatus 100”.

The information processing apparatus 100 uses an autoencoder that estimates a three-dimensional density map from a two-dimensional cryoEM particle image group obtained by cryoEM. This autoencoder corresponds to the CryoTWIN 10 described in FIG. 1 and includes the encoder 11 and the decoder 12.

The information processing apparatus 100 acquires a distribution (latent distribution Ld) of the latent variables z output from the encoder 11 in the process of training the parameters of the encoder 11 and the decoder 12 of the autoencoder using the training data set.

The information processing apparatus 100 generates the path 20 related to deformation from a start point S to an end point E based on the first and second standards. The path 20 corresponds to the path z₀ illustrated in Formula (2).

The information processing apparatus 100 calculates the latent variables z <definition in the following Formula (9)> by inputting a target two-dimensional cryoEM particle image I <definition in the following Formula (8)> to the encoder 11 of the trained autoencoder. For example, the target two-dimensional cryoEM particle image I is an image obtained by imaging the analysis target protein from a plurality of orientations by cryoEM. The information processing apparatus 100 may use the particle image of the training data set as the two-dimensional cryoEM particle image I.

$${\{ {I}_{i} \}}_{i = 1}^{n} \qquad ( 8 )$$

$${\{ {z}_{i} \}}_{i = 1}^{n} \qquad ( 9 )$$

The information processing apparatus 100 searches for a neighboring latent variable <definition in the following Formula (10)> in which the geodesic distance is less than a threshold with respect to a point sequence of the path 20 from the latent variables z defined in Formula (9). The information processing apparatus 100 obtains a neighboring cryoEM particle image corresponding to the neighboring latent variable defined in Formula (10) <definition in the following Formula (11)>.

$${\{ {z}_{i}^{′} \}}_{j = 1}^{m} \qquad ( 10 )$$

$${\{ {I}_{j}^{′} \}}_{j = 1}^{m} \qquad ( 11 )$$

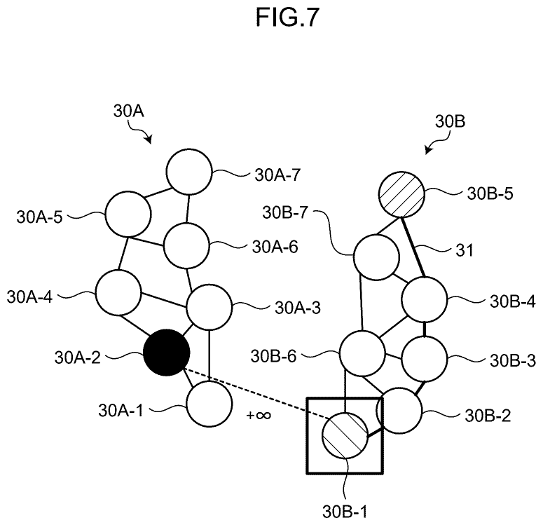

FIG. 7 is a diagram illustrating a geodesic distance. In the example illustrated in FIG. 7, node groups 30A and 30B are illustrated. The node group 30A includes nodes 30A-1, 30A-2, 30A-3, 30A-4, 30A-5, 30A-6, and 30A-7. The node group 30B includes nodes 30B-1, 30B-2, 30B-3, 30B-4, 30B-5, 30B-6, and 30B-7. Each node corresponds to a protein molecule or the like.

For example, since the node group 30A and the node group 30B are not connected, the geodesic distance between the nodes 30A-2 and 30B-1 is “infinite”. On the other hand, since the nodes 30B-1 and 30B-5 are connected via the nodes 30B-2 to 30B-4, the geodesic distance is a distance of a line segment 31 via the nodes 30B-1 to 30B-5.

The geodesic distance has been described above.

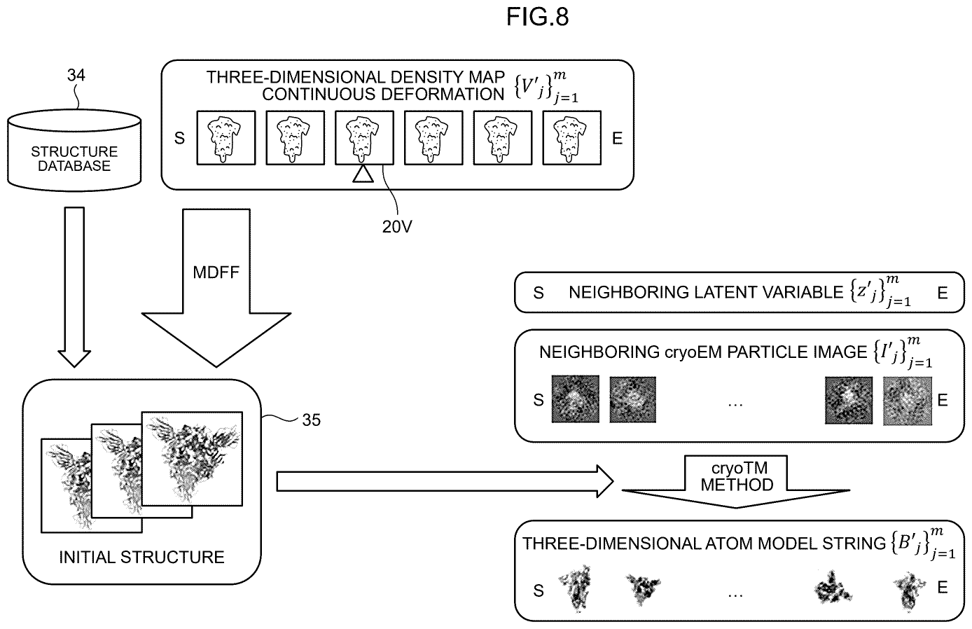

The description returns to the processing of the information processing apparatus 100. FIG. 8 is a diagram (2) illustrating processing of the information processing apparatus according to the present embodiment. The information processing apparatus 100 prepares an initial structure used in the CryoTM method in advance. For example, the information processing apparatus 100 acquires a typical three-dimensional atom model from a structure database 145 or the like, and sets the model as the initial structure 35. The information processing apparatus 100 may estimate a three-dimensional atom model from a three-dimensional density map with relatively high accuracy using the MDFF and set the initial structure. The relatively accurate three-dimensional density map is a three-dimensional density map 20V (FIG. 8) obtained by inputting the latent variable 20z (FIG. 6) on the path 20 into the trained decoder 12.

The information processing apparatus 100 estimates a three-dimensional atom model sequence <definition in the following Formula (12)> from the initial structure 35 prepared in advance for the neighboring cryoEM particle image using the CryoTM method. The neighboring cryoEM particle image may be denoised. In this case, a target can start from the neighboring latent variable closest to the initial structure in the latent space to be gradually expanded.

$${\{ {B}_{j}^{′} \}}_{j = 1}^{m} \qquad ( 12 )$$

As described above, the information processing apparatus 100 acquires the latent distribution output from the encoder 11 in the process of training the autoencoder using the training data set, and generates the path 20 based on the latent distribution. The information processing apparatus 100 selects a plurality of neighboring latent variables in which a distance to the path 20 is less than a threshold from the plurality of latent variables generated by inputting the two-dimensional cryoEM particle images of the analysis target protein to the trained encoder 11. The information processing apparatus 100 estimates a plurality of three-dimensional atom models based on a plurality of neighboring particle images corresponding to the plurality of selected neighboring latent variables. Accordingly, it is possible to accurately estimate the likelihood continuous deformation of the three-dimensional atom model of the protein.

For example, since the information processing apparatus 100 estimates a plurality of three-dimensional atom models based on a neighboring particle image corresponding to a latent variable near the path 20 generated based on the first and second standards, it is possible to avoid an accuracy problem of the three-dimensional density map described in the technique 1 of the related art.

The information processing apparatus 100 selects a plurality of neighboring latent variables in which the geodesic distance to the path 20 is less than the threshold. Accordingly, it is possible to select a likelihood latent variable.

The information processing apparatus 100 estimates a plurality of three-dimensional atom models corresponding to a plurality of neighboring cryoEM particle images corresponding to a plurality of selected neighboring latent variables using the CryoTM method. Accordingly, it is possible to estimate the continuous deformation more accurately.

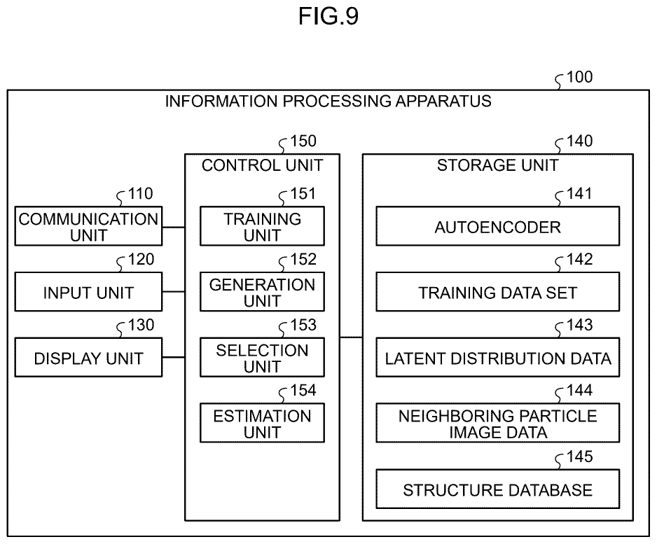

Next, a configuration example of the information processing apparatus 100 that executes the above processing will be described. FIG. 9 is a functional block diagram illustrating a configuration of an information processing apparatus according to the present embodiment. As illustrated in FIG. 9, the information processing apparatus 100 includes a communication unit 110, an input unit 120, a display unit 130, a storage unit 140, and a control unit 150.

The communication unit 110 executes data communication with an external apparatus or the like via a network. Further, the communication unit 110 may receive a training data set 142 or the like from an external apparatus.

The input unit 120 inputs various types of information to the control unit 150.

The display unit 130 displays the information output from the control unit 150.

The storage unit 140 includes an autoencoder 141, a training data set 142, latent distribution data 143, neighboring particle image data 144, and a structure database 145. The storage unit 140 is a memory or the like.

The autoencoder 141 corresponds to the CryoTWIN 10 described in FIG. 1. The autoencoder 141 includes the encoder 11 and the decoder 12.

The training data set 142 is used when the autoencoder 141 is trained. The training data set includes a plurality of pieces of training data. For example, an explanatory variable (input data) of the training data is a particle image of a protein. An objective variable (correct data) of the training data is a three-dimensional density map of a protein (three-dimensional Fourier volume corresponding to the three-dimensional density map, or the like).

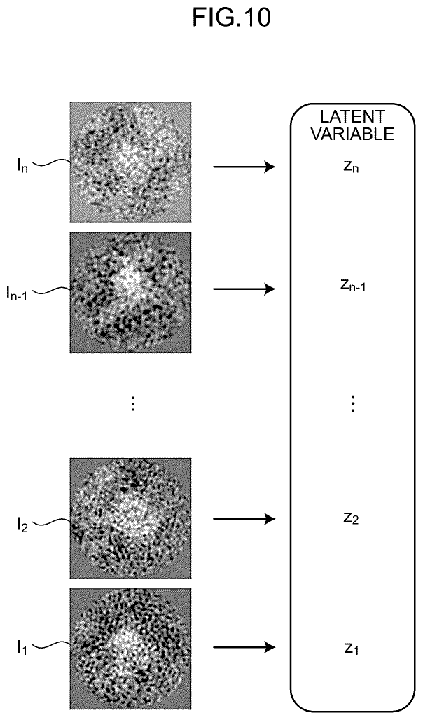

The particle image of the training data is a two-dimensional cryoEM particle image obtained in an experiment. FIG. 10 is a diagram illustrating an example of a two-dimensional cryoEM particle image obtained in an experiment. In the example illustrated in FIG. 10, two-dimensional cryoEM particle images Iₙ, Iₙ₋₁, . . . , I₂, and I₁ are illustrated. For example, when the information processing apparatus 100 inputs Fourier images of the two-dimensional cryoEM particle images Iₙ, Iₙ₋₁, . . . , I₂, and I₁ to the encoder 11 of the autoencoder 141, the latent variables zₙ, zₙ₋₁, . . . , z₂, and z₁ are output from the encoder 11.

The latent distribution data 143 is a distribution (latent distribution) of the latent variables z output from the encoder 11 in the process of training the autoencoder 141 using the training data set 142. The latent distribution is a Gaussian distribution P_{ψ}′(z) as indicated in Formula (6).

The neighboring particle image data 144 is data of particle images corresponding to the neighboring latent variables in which the geodesic distance is less than the threshold with respect to the point sequence of the path 20 described with reference to FIG. 6. For example, the neighboring particle image data 144 is the neighboring cryoEM particle image illustrated in FIG. 8.

The structure database 145 has a typical three-dimensional atom model used as an initial structure of the CryoTM method.

Next, description proceeds to the control unit 150. The control unit 150 includes a training unit 151, a generation unit 152, a selection unit 153, and an estimation unit 154. The control unit 150 is a central processing unit (CPU), a graphics processing unit (GPU), or the like.

The training unit 151 trains the autoencoder 141 (the encoder 11 and the decoder 12) using the training data set 142. The processing for causing the training unit 151 to train the autoencoder 141 is similar to the processing for causing the apparatus described in FIG. 1 to train the encoder 11 and the decoder 12. In the process of training the autoencoder 141, the training unit 151 acquires a distribution (latent distribution) of the latent variables z output from the encoder 11, and registers the acquired latent distribution in the storage unit 140 as the latent distribution data 143.

The generation unit 152 generates the path z₀ as illustrated in Formula (2) based on the latent distribution data 143. For example, the generation unit 152 generates the path z₀ based on the first and second standards. The path z₀ corresponds to the path 20 illustrated in FIG. 6. The generation unit 152 outputs the data of the path z₀ to the selection unit 153.

The selection unit 153 calculates the latent variable z defined in Formula (9) by inputting the target two-dimensional cryoEM particle image I to the encoder 11 of the trained autoencoder 141. The selection unit 153 uses the particle image of the training data set 142 as the target two-dimensional cryoEM particle image I.

The selection unit 153 selects a neighboring latent variable in which the geodesic distance is less than the threshold from the latent variable z defined in Formula (9) with respect to the point sequence of the path z₀. The neighboring latent variable is defined in Formula (10).

The selection unit 153 selects the neighboring cryoEM particle image corresponding to the neighboring latent variable from the particle images of the training data set 142. The neighboring cryoEM particle image is defined as in Formula (11). The selection unit 153 outputs the selected neighboring cryoEM particle image to the estimation unit 154.

Other description of the selection unit 153 is similar to the content described in FIGS. 6 and 8.

The estimation unit 154 acquires a typical three-dimensional atom model to be the initial structure 35 from the structure database 145. The estimation unit 154 estimates a three-dimensional atom model sequence from the initial structure 35 for the neighboring cryoEM particle image using the CryoTM method. The three-dimensional atom model sequence is defined in Formula (12).

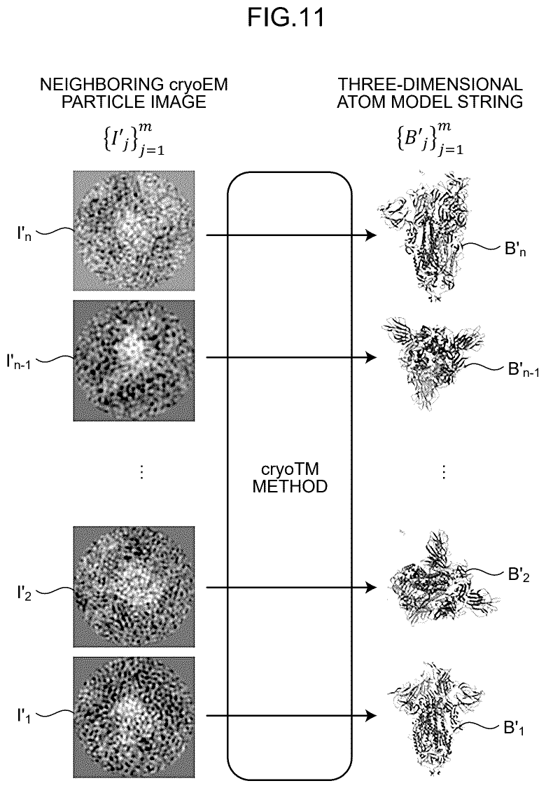

FIG. 11 is a diagram supplementarily illustrating the processing of the estimation unit. For example, the estimation unit 154 estimates a three-dimensional atom model B′ₙ by applying the CryoTM method to a neighboring cryoEM particle image I′ₙ. The estimation unit 154 estimates a three-dimensional atom model B′ₙ₋₁ by applying the CryoTM method to the neighboring CryoEM particle image I′ₙ₋₁. The estimation unit 154 estimates a three-dimensional atom model B′₂ by applying the CryoTM method to a neighboring cryoEM particle image I′₂. The estimation unit 154 estimates a three-dimensional atom model B′₁ by applying the CryoTM method to a neighboring cryoEM particle image I′₁.

The estimation unit 154 outputs the three-dimensional atom model sequence as the estimation result to the display unit 130 to display three-dimensional atom model sequence. Other description of the estimation unit 154 is similar to the processing described in FIG. 8.

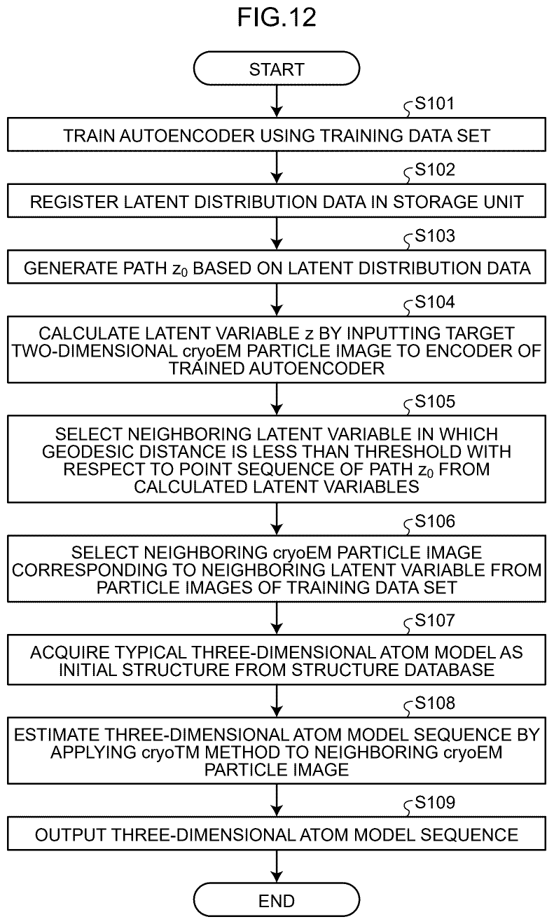

Next, an example of a processing procedure of the information processing apparatus 100 according to the present embodiment will be described. FIG. 12 is a flowchart illustrating a processing procedure of the information processing apparatus according to the present embodiment. As illustrated in FIG. 12, the training unit 151 of the information processing apparatus 100 trains the autoencoder 141 using the training data set 142 (step S101). The training unit 151 registers the latent distribution data 143 output from the encoder 11 during training in the storage unit 140 (step S102).

The generation unit 152 of the information processing apparatus 100 generates the path z₀ based on the latent distribution data 143 (step S103). The selection unit 153 of the information processing apparatus 100 calculates the latent variable z by inputting the target two-dimensional cryoEM particle image I to the encoder 11 of the trained autoencoder 141 (step S104).

The selection unit 153 selects a neighboring latent variable in which the geodesic distance is less than the threshold with respect to the point sequence of the path z₀ from the calculated latent variable z (step S105). The selection unit 153 selects the neighboring cryoEM particle image corresponding to the neighboring latent variable from the particle images of the training data set 142 (step S106).

The estimation unit 154 of the information processing apparatus 100 acquires a typical three-dimensional atom model to be the initial structure 35 from the structure database 145 (step S107). The estimation unit 154 estimates the three-dimensional atom model sequence by applying the CryoTM method to the neighboring cryoEM particle image (step S108). The estimation unit 154 outputs the three-dimensional atom model sequence to the display unit 130 to display the three-dimensional atom model sequence (step S109).

Next, effects of the information processing apparatus 100 according to the present embodiment will be described. In the process of training the autoencoder using the training data set, the information processing apparatus 100 acquires a latent distribution output from the encoder, and generates a path based on the latent distribution. The information processing apparatus 100 selects a plurality of neighboring latent variables in which the distance to the path is less than the threshold from a plurality of latent variables generated by inputting the two-dimensional cryoEM particle image of the analysis target protein to the trained encoder. The information processing apparatus 100 estimates a plurality of three-dimensional atom model sequences based on a plurality of neighboring particle images corresponding to the plurality of selected neighboring latent variables. Accordingly, it is possible to accurately estimate the likelihood continuous deformation of the three-dimensional atom model of the protein.

Incidentally, the content of the processing of the above-described information processing apparatus 100 is exemplary, and the information processing apparatus 100 may execute other processing. Hereinafter, types of other processing (1) and (2) of the information processing apparatus 100 will be described in order.

The “other processing (1)” executed by the information processing apparatus 100 will be described. In the above description, the information processing apparatus 100 selects the neighboring latent variable in which the geodesic distance is less than the threshold from the latent variables z defined in Formula (9) with respect to a point sequence of the path z₀, but uses the latent variable included in the path z₀ as it is in the other processing (1).

For example, the estimation unit 154 of the information processing apparatus 100 generates the cryoEM particle image corresponding to each latent variable by inputting each latent variable included in the path z₀ to the decoder 12 of the trained autoencoder 141.

The estimation unit 154 estimates a three-dimensional atom model sequence from the initial structure 35 for the generated cryoEM particle image using the CryoTM method.

As described above, in the other processing (1), the information processing apparatus 100 can obtain a three-dimensional atom model sequence corresponding to the point sequence by associating the three-dimensional atom model with the cryoEM particle image obtained by the decoder 12 from the point sequence on the path by the CryoTM method.

The “other processing (2)” executed by the information processing apparatus 100 will be described. In the above description, the information processing apparatus 100 uses the distribution of the latent variables z output from the encoder 11 as the latent distribution data 143 in the process of training the autoencoder 141 using the training data set 142, but the present invention is not limited thereto.

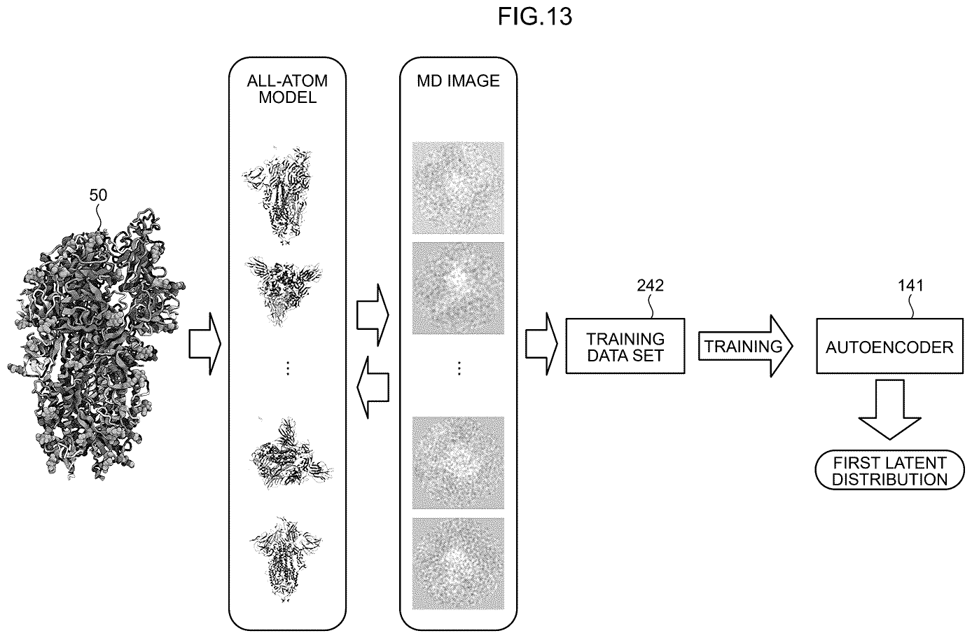

FIG. 13 is a diagram illustrating the other processing (2) executed by the information processing apparatus. The information processing apparatus 100 executes MD of the all-atom model 50 of a protein, and generates an all-atom model {Bₙ} of which a structure has been changed by structure sampling. The information processing apparatus 100 obtains MD images {Iₙ} in which cryoEM particle images are simulated for the all-atom model {Bₙ} and which have various orientations.

The information processing apparatus 100 acquires correct data corresponding to the MD image {Iₙ} described in FIG. 13, generates a training data set 242, and trains the autoencoder 141 using the training data set 242. Iₙ the training process, the information processing apparatus 100 acquires the distribution of the latent variables output from the encoder 11 of the autoencoder 141 as the first latent distribution.

On the other hand, the information processing apparatus 100 trains the autoencoder 141 using the training data set 142 prepared in advance, similarly to the above embodiment. In the training process, the information processing apparatus 100 acquires the distribution of the latent variables output from the encoder 11 of the autoencoder 141 as a second latent distribution.

The information processing apparatus 100 may further train the autoencoder 141 using the training data set 142 after training with the training data set 242, or may train the autoencoder 141 using the training data set 142 after temporarily resetting the parameters of the autoencoder 141.

The information processing apparatus 100 generates the path z₀ based on the latent distribution obtained by superimposing the first and second latent distributions. The processing after the information processing apparatus 100 generates the path z₀ is similar to the processing described in the above embodiment.

That is, the information processing apparatus 100 selects the neighboring latent variable in which the geodesic distance is less than the threshold from the latent variables z defined in Formula (9) with respect to the point sequence of the path z₀. The information processing apparatus 100 selects the neighboring cryoEM particle image corresponding to the neighboring latent variable from the particle images of the training data sets 142 and 242. The information processing apparatus 100 estimates a three-dimensional atom model sequence from the initial structure 35 for the neighboring cryoEM particle image using the CryoTM method.

As described above, in the other processing (2), the information processing apparatus 100 executes MD on the all-atom model 50 of the protein, generates an all-atom model {B,} having a structure changed by structure sampling, acquires MD images {I,} in various orientations, and acquires the first latent distribution by training using the MD images {I,}. The information processing apparatus 100 generates the path z₀ generated from the latent distribution obtained by superimposing the first and second latent distributions. Accordingly, the path z₀ can be generated with the latent distribution in consideration of not only the particle image of the training data set 142 but also the MD images {I,} of various orientations obtained from the all-atom model {B,}.

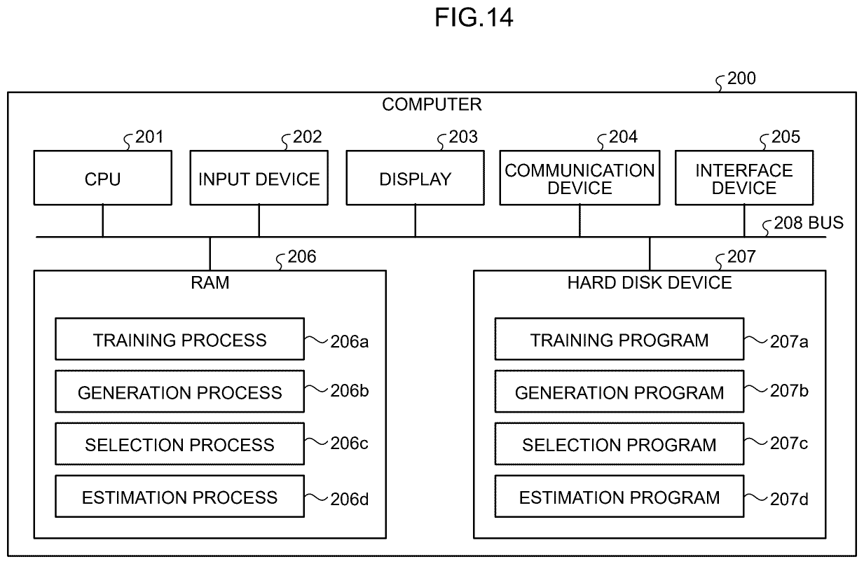

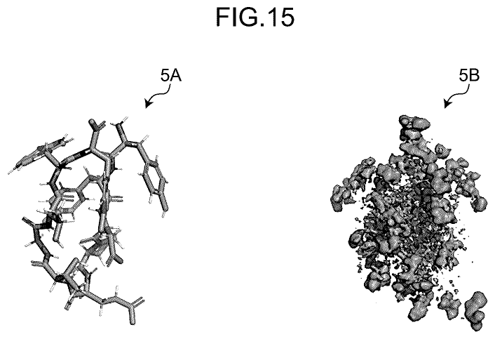

Next, an example of a hardware configuration of a computer that implements functions similar to those of the above-described information processing apparatus 100 will be described. FIG. 14 is a diagram illustrating an example of a hardware configuration of a computer that implements functions similar to those of the information processing apparatus according to the embodiment.

As illustrated in the drawing, the computer 200 includes a CPU 201 that executes various types of arithmetic processing, an input device 202 that accepts an input of data from a user, and a display 203. The computer 200 includes a communication device 204 that exchanges data with an external apparatus or the like via a wired or wireless network, and an interface device 205. The computer 200 includes a RAM 206 that temporarily stores various types of information and a hard disk device 207. The devices 201 to 207 are connected to a bus 208.

The hard disk device 207 includes a training program 207a, a generation program 207b, a selection program 207c, and an estimation program 207d. The CPU 201 reads the programs 207a to 207d and loads the programs in the RAM 206.

The training program 207a functions as a training process 206a. The generation program 207b functions as a generation process 206b. The selection program 207c functions as a selection process 206c. The estimation program 207d functions as an estimation process 206d.

Processing of the training process 206a corresponds to processing of the training unit 151. Processing of the generation process 206b corresponds to processing of the generation unit 152. Processing of the selection process 206c corresponds to processing of the selection unit 153. Processing of the estimation process 206d corresponds to processing of the estimation unit 154.

The programs 207a to 207d do not necessarily need to be stored in the hard disk device 207 from the beginning. For example, each program is stored in a “portable physical medium” such as a flexible disk (FD), a CD-ROM, a DVD, a magneto-optical disc, or an IC card inserted into the computer 200. The computer 200 may read and execute the programs 207a to 207d.

It is possible to accurately estimate a likelihood continuous deformation of a three-dimensional atom model regarding a polymer such as a protein.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer-readable recording medium having stored therein a estimation program that causes a computer to execute a process comprising:
acquiring a distribution of latent variables output from an encoder in a process of training an autoencoder having the encoder and a decoder using a plurality of pieces of training data having a particle image of a polymer as an explanatory variable and having a three-dimensional density map of the polymer as an objective variable;
generating a path related to deformation based on the distribution of the latent variables;
selecting, from a plurality of latent variables generated by inputting a plurality of particle images to the trained encoder, a plurality of neighboring latent variables of which a distance to the path is less than a threshold;
selecting a plurality of neighboring particle images corresponding to the plurality of neighboring latent variables among the plurality of particle images; and
estimating a plurality of three-dimensional atom models based on the plurality of neighboring particle images.

2. The non-transitory computer-readable recording medium according to claim 1, wherein the process further includes estimating the plurality of three-dimensional atom models from the plurality of neighboring particle images using a cryoTM (template matching) method.

3. The non-transitory computer-readable recording medium according to claim 1, wherein the process further includes generating the path based on a first standard indicating that a sum value of probabilities of latent variables included in the path becomes higher and a second standard indicating that a length of the path is made as short as possible.

4. The non-transitory computer-readable recording medium according to claim 1 wherein the process further includes acquiring a plurality of images based on a plurality of all-atom models obtained by changing a structure of an all-atom model of the polymer, and acquiring a distribution of the latent variables by using the plurality of acquired images as explanatory variables of the training data.

5. The non-transitory computer-readable recording medium according to claim 1, wherein the process further includes, selecting a plurality of neighboring latent variables in which the geodesic distance to the path is less than the threshold from a plurality of latent variables generated by inputting a plurality of images to the trained encoder.

6. The non-transitory computer-readable recording medium according to claim 1, wherein the process further includes estimating the plurality of three-dimensional atom models based on a plurality of particle images corresponding to latent variables included in the path.

7. An estimation method comprising:
acquiring a distribution of latent variables output from an encoder in a process of training an autoencoder having the encoder and a decoder using a plurality of pieces of training data having a particle image of a polymer as an explanatory variable and having a three-dimensional density map of the polymer as an objective variable;
generating a path related to deformation based on the distribution of the latent variables;
selecting, from a plurality of latent variables generated by inputting a plurality of particle images to the trained encoder, a plurality of neighboring latent variables of which a distance to the path is less than a threshold;
selecting a plurality of neighboring particle images corresponding to the plurality of neighboring latent variables among the plurality of particle images; and
estimating a plurality of three-dimensional atom models based on the plurality of neighboring particle images, by using a processor.

8. The estimation method according to claim 7, further including estimating the plurality of three-dimensional atom models from the plurality of neighboring particle images using a cryoTM (template matching) method.

9. The estimation method according to claim 7, further including generating the path based on a first standard indicating that a sum value of probabilities of latent variables included in the path becomes higher and a second standard indicating that a length of the path is made as short as possible.

10. The estimation method according to claim 7 further including acquiring a plurality of images based on a plurality of all-atom models obtained by changing a structure of an all-atom model of the polymer, and acquiring a distribution of the latent variables by using the plurality of acquired images as explanatory variables of the training data.

11. The estimation method according to claim 7, further including selecting a plurality of neighboring latent variables in which the geodesic distance to the path is less than the threshold from a plurality of latent variables generated by inputting a plurality of images to the trained encoder.

12. The estimation method according to claim 7, further including estimating the plurality of three-dimensional atom models based on a plurality of particle images corresponding to latent variables included in the path.

13. An information processing apparatus comprising:
a memory; and
a processor coupled to the memory and configured to:
acquire a distribution of latent variables output from an encoder in a process of training an autoencoder having the encoder and a decoder using a plurality of pieces of training data having a particle image of a polymer as an explanatory variable and having a three-dimensional density map of the polymer as an objective variable;
generate a path related to deformation based on the distribution of the latent variables;
select, from a plurality of latent variables generated by inputting a plurality of particle images to the trained encoder, a plurality of neighboring latent variables in which a distance to the path is less than a threshold;
select a plurality of neighboring particle images corresponding to the plurality of neighboring latent variables among the plurality of particle images; and
estimate a plurality of three-dimensional atom models based on the plurality of neighboring particle images.

14. The information processing apparatus according to claim 13, wherein the processor is further configured to estimate the plurality of three-dimensional atom models from the plurality of neighboring particle images using a template matching (TM) method.

15. The information processing apparatus according to claim 13, wherein the processor is further configured to generate the path based on a first standard indicating that a sum value of probabilities of latent variables included in the path becomes higher and a second standard indicating that a length of the path is made as short as possible.

16. The information processing apparatus according to claim 13, wherein the processor is further configured to acquire a plurality of images based on a plurality of all-atom models obtained by changing a structure of an all-atom model of the polymer, and acquire a distribution of the latent variables by using the plurality of acquired images as explanatory variables of the training data.

17. The information processing apparatus according to claim 13, wherein the processor is further configured to, select a plurality of neighboring latent variables in which the geodesic distance to the path is less than the threshold from a plurality of latent variables generated by inputting a plurality of images to the trained encoder.

18. The information processing apparatus according to claim 13, wherein the processor is further configured to estimate the plurality of three-dimensional atom models based on a plurality of particle images corresponding to latent variables included in the path.
